(19) United States
(12) Patent Application Publication
(10) Pub. No.: US 2023/0171638 A1
(43) Pub. Date: Jun. 1, 2023

(54) COMMUNICATION SYSTEM

(71) Applicant: HONDA MOTOR CO., LTD., Tokyo (JP)

(72) Inventors: Ryusuke Tamanaha, Tokyo (JP); Motoki Ito, Tokyo (JP)

(21) Appl. No.: 17/983,001

(22) Filed: Nov. 8, 2022

(30) Foreign Application Priority Data
Nov. 30, 2021 (JP) 2021-194711

(51) Int. Cl. H04W 28/02; H04W 40/22; G07C 5/00

(52) U.S. Cl. CPC H04W 28/0289; H04W 40/22; G07C 5/008

(57) ABSTRACT

A communication system includes: a determination section that determines occurrence of an event; and a communication control section that relays between a first communication network communicating with an external communication apparatus and a second communication network communicating with a mobile communication terminal. The communication control section sets a control target of a communication volume of at least one of a first communication and a second communication among communications via the first communication network, based on a result of determination of occurrence of the event. The first communication is performed through other processing than relaying processing, and the second communication is performed through the relaying processing.

### INCORPORATION BY REFERENCE

The present application claims priority under 35 U.S.C. § 119 to Japanese Patent Application No. 2021-194711 filed on Nov. 30, 2021. The content of the application is incorporated herein by reference in its entirety.

### BACKGROUND OF THE INVENTION

### Field of the Invention

The present invention relates to a communication system.

### Description of the Related Art

Conventionally, a system has been proposed in which a driving recorder mounted on a mobile object is configured to include a function of communicating with an external image collection apparatus provided outside of the mobile object, and to transmit an image captured by the driving recorder to the image collection apparatus (for example, see Japanese Patent Laid-Open No. 2020-177677). In the system, captured images are used for detection of an accident and for other purposes, such as fixed-point observation, search for a stray child, and check on a situation at a fire site.

In order to collect images captured by a communication system including a camera, such as a driving recorder, and to use the captured images for various purposes, it is necessary to transmit more captured images to an image collection apparatus by increasing the number of timings at which an image is captured by the communication system. To this end, it is preferable to restrain communication costs borne by a user when captured images are transmitted from the communication system, and thereby to prevent the communication costs from constituting an obstacle to the transmission of captured images.

The present invention has been made in view of such a background, and an object of the present invention is to provide a communication system that can reduce communication costs incurred when captured images are transmitted.

The object can also lead to enhanced energy efficiency in information communication, through a reduction in communication volume, and to a reduction in the number of victims in a disaster or an accident, through contribution to the swift provision of information related to the disaster or the accident, so that the object can contribute to the realization of a sustainable society (SDGs 7.3, 11.5).

### SUMMARY OF THE INVENTION

One aspect of the present invention is a communication system including: a first communication section that performs communication via a first communication network with an external communication apparatus; a second communication section that performs communication via a second communication network with a mobile communication terminal; a communication control section that controls operation of the first communication section and the second communication section; and a determination section that determines whether or not a predetermined event occurs, wherein the communication control section performs communication relaying processing of performing communication between the mobile communication terminal and the external communication apparatus, by relaying between the first communication network and the second communication network by using the first communication section and the second communication section, and the communication control section sets at least one of a control target relevant to a first communication volume related to a first communication and a control target relevant to a second communication volume related to a second communication, based on a result of determination performed by the determination section as to whether or not the predetermined event occurs, the first communication being not a communication through the communication relaying processing among communications via the first communication network, the second communication being a communication through the communication relaying processing among communications via the first communication network.

According to another aspect of the present invention, when it is determined by the determination section that the event occurs, the communication control section sets a control target of the first communication volume, or a control target of a ratio of the first communication volume to the second communication volume, at a larger value than when it is determined that the event does not occur.

According to another aspect of the present invention, when it is determined by the determination section that the event occurs, the communication control section sets a control target of the second communication volume, or a control target of a ratio of the second communication volume to the first communication volume, at a smaller value than when it is determined that the event does not occur.

According to another aspect of the present invention, the first communication is a communication that transmits image data captured by an image pick-up device to the external communication apparatus.

According to another aspect of the present invention, the determination section determines whether or not the event occurs, based on image data captured by an image pick-up device.

According to another aspect of the present invention, occurrence of the event that is determined by the determination section is occurrence of a predetermined abnormal state in an installation environment where the image pick-up device is installed.

According to another aspect of the present invention, the abnormal state includes existence of a disaster, an accident, an emergency vehicle, and/or a suspicious person in the installation environment.

According to another aspect of the present invention, the determination section determines whether or not the event occurs, based on behavior of a mobile object on which the communication system is used.

According to another aspect of the present invention, occurrence of the event that is determined by the determination section is occurrence of a predetermined abnormal state of the behavior of the mobile object.

According to another aspect of the present invention, the abnormal state includes abrupt steering, sudden braking, and/or a collision of the mobile object.

According to another aspect of the present invention, when it is determined by the determination section that the event occurs, the communication control section informs the mobile communication terminal, by using the second communication section, of at least one of occurrence of the event and limitation to a communication volume of the second communication.

According to another aspect of the present invention, the communication system includes a camera including an image pick-up device, or a driving recorder including an image pick-up device.

According to another aspect of the present invention, the communication system is provided to a mobile object, and as the communication relaying processing, the communication control section relays a communication to or from the external communication apparatus, for the mobile communication terminal existing in the mobile object.

According to any aspect of the present invention, it is possible to provide a communication system that can reduce communication costs incurred when captured images are transmitted.

### BRIEF DESCRIPTION OF THE DRAWINGS

FIG. 1 is a diagram for describing a scenario in which a communication system according to an embodiment of the present invention is used;

FIG. 2 shows a configuration of the communication system;

FIG. 3 is an example of changes over time in a first communication volume C1 when the first communication volume C1 is adjusted by a communication control section;

FIG. 4 is an example of changes over time in the first communication volume C1 when a ratio R is adjusted by the communication control; and

FIG. 5 is a flowchart showing a procedure of communication volume control operation in the communication system.

### DETAILED DESCRIPTION OF THE PREFERRED EMBODIMENTS

Hereinafter, embodiments of the present invention are described.

[1. Scenario in which Communication System is Used]

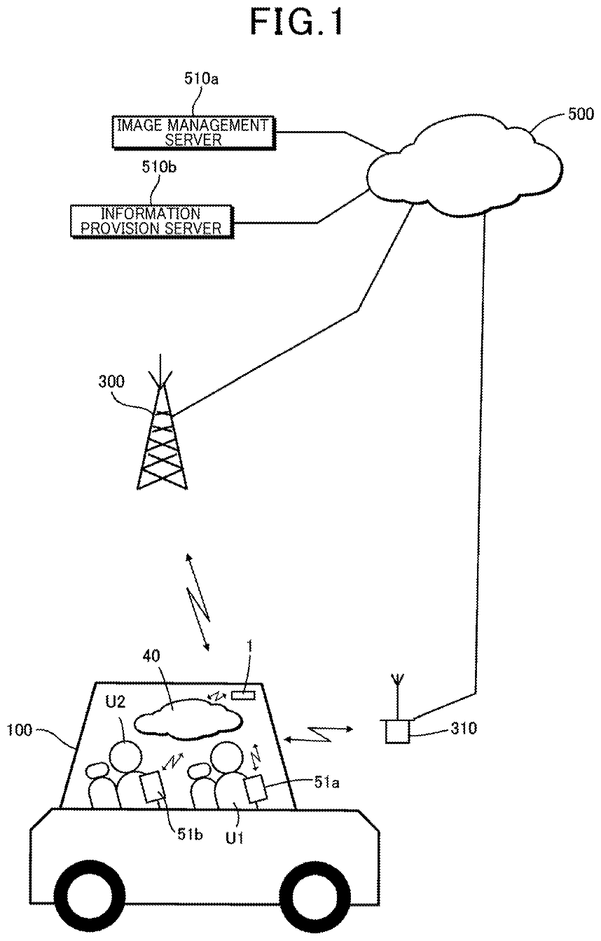

FIG. 1 is a diagram showing an example of a scenario in which a communication system 1 according to an embodiment of the present invention is used. In the present embodiment, the communication system 1 is implemented, for example, as a driving recorder. The communication system 1 is used in a form of being mounted on a vehicle 100, and has a function of capturing images of surroundings of the vehicle 100 and an inside of a vehicle cabin of the vehicle 100 by using an image pick-up device, and transmitting the captured images to an external communication apparatus provided outside of the vehicle 100. The vehicle 100 corresponds to a mobile object in the present disclosure.

The communication system 1 has a function of performing cellular communication and Wi-Fi(R) communication. The communication system 1 performs communication with the external communication apparatus via a wide area network 500 by performing cellular communication with a base station 300 in each cell, or by performing Wi-Fi communication with a router 310 installed at a Wi-Fi spot near a road. In FIG. 1, for the external communication apparatus, an image management server 510a and an information provision server 510b are illustrated. The wide area network 500 corresponds to a first communication network in the present disclosure. Hereinafter, the image management server 510a and the information provision server 510b are also collectively referred to as the external communication apparatus 510.

Moreover, the communication system 1 builds an in-vehicle communication network 40 by establishing Wi-Fi communication with mobile communication terminals 51a, 51b used respectively by users U1, U2 who are aboard the vehicle 100. Further, the communication system 1 has a function as a Wi-Fi router that relays between the in-vehicle communication network 40 and the wide area network 500. The in-vehicle communication network 40 corresponds to a second communication network in the present disclosure.

The mobile communication terminals 51a, 51b are any of a smartphone, a mobile telephone, a tablet terminal, a portable game console, and the like. Hereinafter, the users U1 and U2 are also collectively referred to as the user U, and the mobile communication terminals 51a, 51b are also collectively referred to as the mobile communication terminal 51.

Even if the mobile communication terminal 51 does not have cellular communication functionality, the user U can perform communication with the information provision server 510b via the in-vehicle communication network 40 provided by the communication system 1. Note that, for example, when the vehicle 100 is parked or stopped, the communication system 1 may relay between a mobile communication terminal outside of the vehicle 100 and the external communication apparatus 510 by using the in-vehicle communication network 40, depending on a radio wave range of the communication system 1.

The communication system 1 transmits an image captured by the image pick-up device, which will be described later, to the image management server 510a via the wide area network 500. The image management server 510a can perform processing for analysis of an accident, fixed-point observation, inspection of a road facility, or the like, by using the captured image received from the communication system 1.

### [2. Configuration of Driving Recorder]

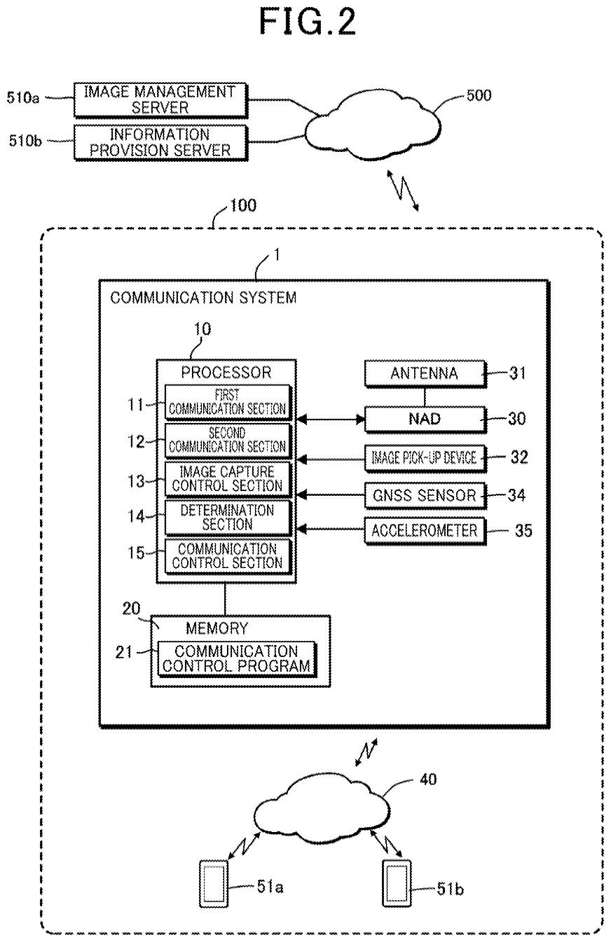

A configuration of the communication system 1 is described with reference FIG. 2. The communication system 1 includes a processor 10, a memory 20, a NAD (Network Access Device) 30, an antenna 31, an image pick-up device 32, a GNSS (Global Navigation Satellite System) sensor 34, and an accelerometer 35.

The NAD 30 is a chip on which a cellular communication module and a Wi-Fi communication module are integrated. The antenna 31 is a dual-purpose antenna that supports cellular communication and Wi-Fi communication.

The image pick-up device 32 is, for example, a CCD (Charge Coupled Device), captures an image of the surroundings of the vehicle 100 and/or an image of the inside of the vehicle cabin of the vehicle 100, and outputs the captured image or images to the processor 10. Note that the communication system 1 can be configured to include a plurality of image pick-up devices 32, depending on the size of an image capture range for the surroundings of the vehicle 100 or for the inside of the vehicle cabin.

The GNSS sensor 34 detects a current position (latitude, longitude) of the communication system 1 by receiving radio waves from positioning satellites, and outputs a position detection signal to the processor 10. The accelerometer 35 is, for example, a three-axis accelerometer, detects respective accelerations in three orthogonal directions occurring in the communication system 1, and outputs sensing outputs indicating respective magnitudes of the accelerations to the processor 10.

The memory 20 includes, for example, a volatile and/or non-volatile semiconductor memory. The processor 10 is a computer included in the communication system 1, which is a communication system, and includes, for example, one or more CPUs (Central Processing Units) or one or more MPUs (Micro Processing Units).

The processor 10 includes, as functional elements or functional units, a first communication section 11, a second communication section 12, an image capture control section 13, a determination section 14, and a communication control section 15. The functional elements included in the processor 10 are implemented, for example, by the processor 10, which is a computer, executing a communication control program 21, which is a computer program stored in the memory 20. Instead, all, or one or some, of the functional elements included in the processor 10 can also be configured by using hardware including one or more electronic circuit parts for each functional element.

The first communication section 11 performs a communication via the wide area network 500, which is the first communication network, with the external communication apparatus 510 (that is, the image management server 510a and the information provision server 510b) by using the NAD 30 and the antenna 31.

The first communication section 11 performs the communication via the wide area network 500 with the external communication apparatus 510, for example, through packet communication. Specifically, the first communication section 11 generates packets in which first communication data inputted from the communication control section 15 and second communication data from the mobile communication terminal 51 are put together. The first communication data includes an image captured by the image pick-up device 32. The first communication section 11 transmits the generated packets to the external communication apparatus 510 via the wide area network 500.

Thus, compared to a case where the first communication data and the second communication data are individually packetized and transmitted, the number of packets transmitted cab be reduced, and the total amount of packet control overheads added to the first communication data and the second communication data can be reduced, so that a communication volume in the wide area network 500 can be reduced. As a result, the communication system 1 can reduce the amount of use of communications using the wide area network 500, and consequently can reduce communication costs.

The second communication section 12 performs a communication via the in-vehicle communication network 40, which is the second communication network, with the mobile communication terminal 51 by using the NAD 30 and the antenna 31.

The image capture control section 13 acquires a captured image from the image pick-up device 32, and transmits the acquired captured image, along with information on a date and time when the image is captured and a position where the image is captured, to the communication control section 15. Here, the image capture control section 13 can be configured to acquire the information on the position where the image is captured by using the GNSS sensor 34.

The determination section 14 determines whether or not a predetermined event occurs. In the present embodiment, the event is, for example, occurrence of a predetermined abnormal state in an installation environment where the image pick-up device 32 is installed, and/or occurrence of an abnormal state of behavior of the vehicle 100, which is a mobile object. The predetermined abnormal state in the installation environment can include existence of a disaster, an accident, an emergency vehicle, and/or a suspicious person in the installation environment. The abnormal state of the behavior of the vehicle 100 can include abrupt steering, sudden braking, and/or a collision of the vehicle 100.

The determination section 14 determines whether or not the predetermined event occurs, for example, based on an image captured by the image pick-up device 32. For example, it is determined whether or not the predetermined abnormality (event) occurs, through image analysis of an image of an external environment around the vehicle, or an image of the inside of the vehicle, captured by the image pick-up device 32. For example, the determination section 14 can determine whether or not the event occurs, based on a behavior of the vehicle 100 perceived from sensing outputs from the accelerometer 35.

Note that the determination section 14 may determine whether or not the predetermined event occurs, not only by using the accelerometer 35, but also by using another sensor included in the vehicle 100. For example, the determination section 14 may acquire an impact detection signal from an impact sensor included in an airbag or the like of the vehicle 100, and may determine whether or not an abnormality in the behavior of the vehicle 100, for example, an abnormal state such as a collision accident occurs.

The communication control section 15 performs image transmission processing and communication relaying processing, by controlling operation of the first communication section 11 and the second communication section 12. The image transmission processing is processing of transmitting an image captured by the image pick-up device 32 to the image management server 510a by using the first communication section 11. Specifically, the communication control section 15 acquires a captured image from the image pick-up device 32 via the image capture control section 13 at predetermined time intervals, and transmits the acquired captured image to the image management server 510a by using the first communication section 11.

The communication relaying processing is processing that the communication system 1 performs as a Wi-Fi router, and processing of relaying communications to and from the in-vehicle communication network 40 and communications to and from the wide area network 500. In the communication relaying processing, the communication control section 15 performs communication between the mobile communication terminals 51a, 51b and the information provision server 510b by relaying between the wide area network 500, which is the first communication network, and the in-vehicle communication network 40, which is the second communication network, by using the first communication section 11 and the second communication section 12. Here, among communications via the first communication network, a communication through the image transmission processing corresponds to a first communication that is not a communication through the communication relaying processing in the present disclosure. In other words, in the present embodiment, the first communication is a communication that transmits image data captured by the image pick-up device 32 to the image management server 510a, which is an external communication apparatus. Moreover, among communications via the first communication network, a communication through the communication relaying processing corresponds to a second communication in the present disclosure.

In the present embodiment in particular, with respect to communications via the wide area network 500, which is the first communication network, performed by using the first communication section 11, the communication control section 15 adjusts a communication volume related to transmission of a captured image, and a communication volume related to the mobile communication terminal 51, depending on a result of determination performed by the determination section 14 as to whether or not the predetermined event occurs. In other words, based on a result of determination performed by the determination section 14 as to whether or not the predetermined event occurs, the communication control section 15 sets at least one of a control target relevant to a first communication volume related to the first communication that is not a communication through the communication relaying processing among communications via the first communication network, and a control target relevant to a second communication volume related to the second communication that is a communication through the communication relaying processing among communications via the first communication network.

Specifically, with respect to communications via the wide area network 500, the communication control section 15 sets a control target of the first communication volume C1 related to transmission of a captured image, which is performed through the image transmission processing, at a value according to a result of determination performed by the determination section 14 as to whether or not the predetermined event occurs. Alternatively or additionally, the communication control section 15 sets a control target of a ratio R (=C1/C2) of the first communication volume C1 to the second communication volume C2 related to a communication through the communication relaying processing, at a value according to a result of determination performed by the determination section 14 as to whether or not the predetermined event occurs. Here, for the first communication volume C1 and the second communication volume C2, a communication volume per unit time can be used.

More specifically, for example, when it is determined by the determination section 14 that the predetermined event occurs, the communication control section 15 sets the control target of the first communication volume C1 at a larger value, or sets the control target of the ratio R of the first communication volume C1 to the second communication volume C2 at a larger value, than when it is determined that the predetermined event does not occur. Moreover, when it is determined, in particular, that a predetermined specific event occurs, the communication control section 15 may set the control target relevant to the second communication volume C2 or the control target relevant to the first communication volume C1, and a control target of a ratio relevant to the two communication volumes, such that the second communication volume C2 becomes zero (almost zero). For the specific event, for example, an abnormal state such as a collision accident may be predetermined.

In other words, when it is determined by the determination section 14 that the predetermined event occurs, the communication control section 15 may set a control target of the second communication volume C2, or a control target of a ratio of the second communication volume C2 to the first communication volume C1, at a smaller value than when it is determined that the predetermined event does not occur. For example, when the specific event occurs, the communication control section 15 can be configured to lower the ratio of the second communication volume C2 to the first communication volume C1, by increasing the first communication volume C1 to approximately an upper-limit communication rate of communications via the wide area network 500 performed by using the first communication section 11, and decreasing the second communication volume C2 to almost zero.

Then, the communication control section 15 controls operation for the image transmission processing and the communication relaying processing in such a manner that the first communication volume C1 or the ratio R becomes the respective set control target value, within a predetermined range of errors. For example, the communication control section 15 can be configured to increase the number of captured images transmitted per unit time to the external communication apparatus 510 by shortening the time interval at which a captured image is acquired from the image capture control section 13 in the image transmission processing, or to increase the first communication volume C1 by raising resolution of a captured image to be transmitted, when it is determined by the determination section 14 that the predetermined event occurs, compared to when it is determined that the predetermined event does not occur.

In the communication system 1 having the above-described configuration, since the communication control section 15 collectively performs transmission of a captured image to the external communication apparatus 510 and communication between the mobile communication terminal 51 and the external communication apparatus 510 by using the first communication section 11, the communication volume in the wide area network 500 decreases, so that communication costs are reduced.

Moreover, in the communication system 1, with respect to communications via the wide area network 500, the control target of the first communication volume C1 related to the image transmission processing, or the control target of the ratio R of the first communication volume C1 to the second communication volume C2 related to the communication relaying processing, is set based on determination as to whether or not the predetermined event occurs, performed by the determination section 14. Thus, for example, during a period when an event, such as an abnormal state that requires more precise examination or the like, keeps occurring, a larger number of images captured at shorter time intervals, or a captured image with higher resolution, can be transmitted to the image management server 510a, and during a period when no abnormal state occurs and little attention is needed, a smaller number of images captured at longer time intervals, or an image with lower resolution, can be transmitted. As a result, according to the communication system 1, while usefulness of a captured image is maintained, the communication volume of communications via the wide area network 500 can be reduced, and communication costs can be consequently reduced, compared to a case where a captured image captured at the same time interval is constantly transmitted at a fixed time interval.

Note that when it is determined by the determination section 14 that the predetermined event occurs, the communication control section 15 may inform the mobile communication terminal 51, by using the second communication section 12, that the event has occurred. Alternatively, in a case of limiting the communication volume of the second communication when it is determined by the determination section 14 that the predetermined event occurs, the communication control section 15 may inform the mobile communication terminal 51, by using the second communication section 12, that the communication volume of the second communication is limited.

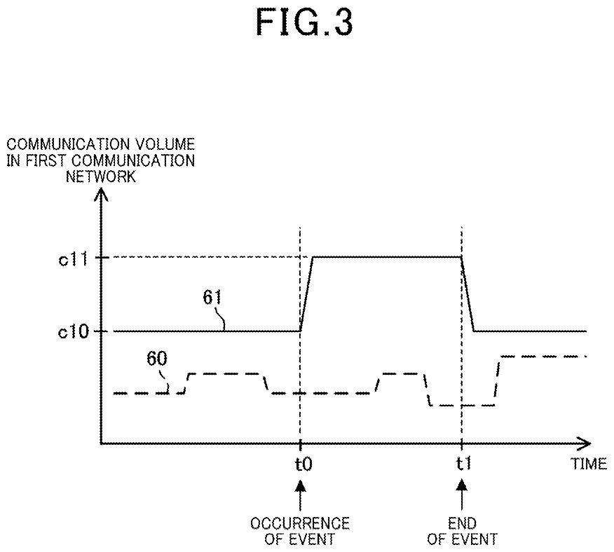

FIG. 3 is an example of changes over time in the first communication volume C1 when the first communication volume C1 is adjusted by the communication control section 15. In FIG. 3, a vertical axis represents communication volumes per unit time of communications via the wide area network 500, which is the first communication network, and a horizontal axis represents time. Moreover, a line 60 shown in FIG. 3 indicates changes over time in the second communication volume C2 through the communication relaying processing. A line 61 indicates changes over time in the first communication volume C1 through the image transmission processing.

The second communication volume C2 indicated by the line 60 changes over time, according to how the user U uses the mobile communication terminal 51 (for example, for telephoning, website browsing, online gaming, and the like).

Here, it is assumed that the determination section 14 determines that the predetermined event, such as an abnormal state, occurs over a period from time t0 to time t1 indicated on the horizontal axis in FIG. 3. Hereinafter time t0 is referred to as the event start time, and time t1 is referred to as the event end time.

On the line 61, before the event start time t0, the communication control section 15 sets the control target value of the first communication volume C1 at, for example, a default value of c10, and controls the image transmission processing in such a manner that the first communication volume C1 stays at c10. Then, in response to determination of occurrence of the event made by the determination section 14 at the event start time t0, the communication control section 15, at the event start time to, increases the control target of the first communication volume C1 from c10 to c11. As described above, the increase in the first communication volume C1 is performed, for example, by the communication control section 15 increasing the number of captured images transmitted per unit time to the external communication apparatus 510, or increasing the resolution of a captured image. Then, when the determination section 14 determines, at the event end time t1, that the predetermined event does not occur, the communication control section 15 sets the control target of the first communication volume C1 from c11 back to c10.

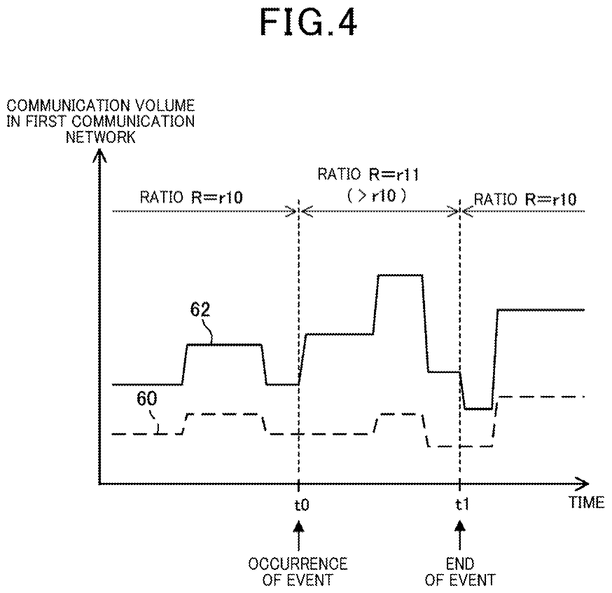

FIG. 4 is an example of changes over time in the first communication volume C1 when the ratio R of the first communication volume C1 to the second communication volume C2 is adjusted by the communication control section 15. A vertical axis and a horizontal axis in FIG. 4 are the same as the vertical axis and the horizontal axis in FIG. 3, respectively. A line 60 shown in FIG. 4 is the same as the line 60 shown in FIG. 3, and indicates changes over time in the second communication volume C2 through the communication relaying processing. A line 62 shown in FIG. 4 indicates changes over time in the first communication volume C1 through the image transmission processing.

On the line 62, before the event start time t0, the communication control section 15 sets the control target of the ratio R of the first communication volume C1 to the second communication volume C2 at, for example, a default value of r10, and controls the image transmission processing in such a manner that the ratio R stays at r10. Then, in response to determination of occurrence of the event made by the determination section 14 at the event start time t0, the communication control section 15, at the event start time t0, increases the control target of the ratio R from r10 to r11. In the example shown in FIG. 4, the increase in the ratio R is achieved by increasing the first communication volume C1. Then, when the determination section 14 determines, at the event end time t1, that the predetermined event does not occur, the communication control section 15 sets the control target of the ratio R from r11 back to r10.

Note that the communication control section 15 may adjust the ratio R by increasing or decreasing the second communication volume C2, in addition to increasing or decreasing the first communication volume C1 as shown at the line 62 in FIG. 4. For example, the communication control section 15 can be configured to increase or decrease the second communication volume C2 by adjusting the amount of information (for example, bit rate) to be transmitted or received per unit time by the mobile communication terminal 51.

### [3. Operation in Communication System]

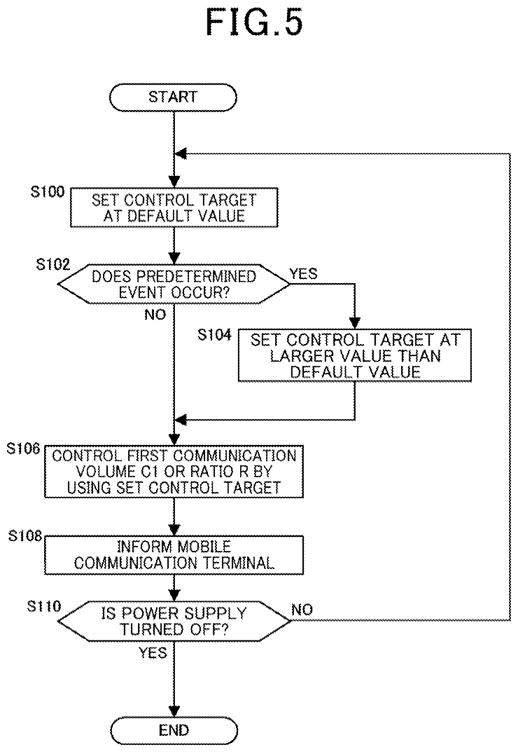

Next, a description is given of communication volume control operation of controlling the first communication volume C1 or the ratio R, in the communication system 1. FIG. 5 is a flowchart showing a procedure of the communication volume control operation in the communication system 1. Processing shown in FIG. 5 is started when a power supply of the communication system 1 is turned on.

When the processing is started, the communication control section 15, with respect to the wide area network 500, sets the control target of the first communication volume C1 in the image transmission processing, or the control target of the ratio R (=C1/C2) of the first communication volume C1 to the second communication volume C2 in the communication relaying processing, at the respective default value (S100).

Next, the determination section 14 determines whether or not the predetermined event occurs (S102). When it is determined that the predetermined event does not occur (S102, NO), the communication control section 15 controls the first communication volume C1 or the ratio R by using the set control target (S106). Thus, while it is determined that the predetermined event does not occur, the communication control section 15 controls the first communication volume C or the ratio R by using the default control target.

When it is determined in step S102 that the predetermined event occurs (S102, YES), the communication control section 15 sets the control target of the first communication volume C1 or the ratio R at a larger value than the respective default value (S104), and moves the processing to step S106. Thus, when the predetermined event occurs, the first communication volume C1 or the ratio R is controlled by the communication control section 15 by using the control target larger than the respective default value.

Subsequently, the communication control section 15 informs the mobile communication terminal 51, by using the second communication section 12, that the predetermined event has occurred, and that the communication volume of the second communication is limited if the communication volume of the second communication is limited (S108).

Subsequently, the communication control section 15 determines whether or not the power supply of the communication system 1 is turned off (S110). When the power supply of the communication system 1 is not turned off (S110, NO), the communication control section 15 moves back to step S100 and repeats the processing. When the power supply of the communication system 1 is turned off (S110, YES), the communication control section 15 terminates the processing.

### [4. Other Embodiments]

Although the four-wheeled vehicle 100 is illustrated as a mobile object on which the communication system 1 is mounted in the above-described embodiment, a mobile object on which the communication system 1 is mounted may be two-wheeled vehicle, a flight vehicle, a ship, or the like.

Although access to the wide area network (corresponding to the first communication network in the present disclosure) is performed through the cellular scheme or Wi-Fi communication in the above-described embodiment, the access may be made through another communication scheme. Although the in-vehicle communication network 40 is assumed to be a Wi-Fi communication network, the in-vehicle communication network 40 may be a network over which communication is performed based on other specifications such as Bluetooth(R).

The communication system 1 in the present disclosure may be configured to be included in a driving recorder having another function such as image storage. The communication system 1 may be configured to be included in a camera whose main purpose is to acquire a captured image by using an image pick-up device, a communication terminal (smartphone, mobile telephone, tablet terminal, or the like) including an image pick-up device, or the like.

Note that FIG. 2 is a schematic diagram in which the configuration of the communication system 1 is shown by being segmented based on main processing contents in order to facilitate understanding of the invention of the present application, and the configuration of the communication system 1 may be segmented based on other categories. The processing by each constituent element may be performed by a single hardware unit, or may be performed by a plurality of hardware units. The processing by each constituent element according to the flowchart shown in FIG. 3 may be performed by using a single program, or may be performed by using a plurality of programs.

### [4. Configurations Supported by the Embodiment]

The above-described embodiment supports configurations as described below.

(Configuration 1) A communication system including: a first communication section that performs communication via a first communication network with an external communication apparatus; a second communication section that performs communication via a second communication network with a mobile communication terminal; a communication control section that controls operation of the first communication section and the second communication section; and a determination section that determines whether or not a predetermined event occurs, wherein the communication control section performs communication relaying processing of performing communication between the mobile communication terminal and the external communication apparatus, by relaying between the first communication network and the second communication network by using the first communication section and the second communication section, and the communication control section sets at least one of a control target relevant to a first communication volume related to a first communication and a control target relevant to a second communication volume related to a second communication, based on a result of determination performed by the determination section as to whether or not the predetermined event occurs, the first communication being not a communication through the communication relaying processing among communications via the first communication network, the second communication being a communication through the communication relaying processing among communications via the first communication network.

According to the communication system in the configuration 1, since a control target of the first communication volume or a control target of the second communication volume is set depending on whether or not the predetermined event occurs, communication costs can be reduced by decreasing a communication volume in the first communication network, while usefulness of a captured image in the predetermined event is maintained.

(Configuration 2) The communication system according to the configuration 1, wherein when it is determined by the determination section that the event occurs, the communication control section sets a control target of the first communication volume, or a control target of a ratio of the first communication volume to the second communication volume, at a larger value than when it is determined that the event does not occur.

According to the communication system in the configuration 2, when the predetermined event occurs, the first communication volume is increased, or the ratio of the first communication volume to the second communication volume is increased. Accordingly, when the predetermined event occurs, usefulness of a captured image transmitted can be enhanced by increasing the number of captured images transmitted or resolution of a captured image, while communication costs can be restrained at normal times when the predetermined event does not occur.

(Configuration 3) The communication system according to the configuration 1, wherein when it is determined by the determination section that the event occurs, the communication control section sets a control target of the second communication volume, or a control target of a ratio of the second communication volume to the first communication volume, at a smaller value than when it is determined that the event does not occur.

According to the communication system in the configuration 3, when the predetermined event occurs, the second communication volume is decreased, or the ratio of the second communication volume to the first communication volume is decreased. Accordingly, when the predetermined event occurs, usefulness of a captured image transmitted can be enhanced by increasing the number of captured images transmitted or resolution of a captured image, while communication costs can be restrained at normal times when the predetermined event does not occur.

(Configuration 4) The communication system according to any one of the configurations 1 to 3, wherein the first communication is a communication that transmits image data captured by an image pick-up device to the external communication apparatus.

According to the communication system in the configuration 4, when the predetermined event occurs, an image of surroundings related to the event can be captured by the image pick-up device and transmitted to the external communication apparatus.

(Configuration 5) The communication system according to any one of the configurations 1 to 4, wherein the determination section determines whether or not the event occurs, based on image data captured by an image pick-up device.

According to the communication system in the configuration 5, occurrence of the predetermined event can be easily determined, without using a special apparatus.

(Configuration 6) The communication system according to the configuration 5, wherein occurrence of the event that is determined by the determination section is occurrence of a predetermined abnormal state in an installation environment where the image pick-up device is installed.

According to the communication system in the configuration 6, since an abnormal state in a surrounding environment is determined as the predetermined event, usefulness of a captured image transmitted can be enhanced by enabling many captured images or a high-definition captured image related to the abnormal state to be transmitted.

(Configuration 7) The communication system according to the configuration 6, wherein the abnormal state includes existence of a disaster, an accident, an emergency vehicle, and/or a suspicious person in the installation environment.

According to the communication system in the configuration 7, in a scene where a captured image of a surrounding environment can play a significant role in analysis of the abnormal state, a sufficient number of captured images or a captured image with sufficient resolution can be transmitted by increasing the first communication volume or the ratio.

(Configuration 8) The communication system according to the configuration 1, wherein the determination section determines whether or not the event occurs, based on behavior of a mobile object on which the communication system is used.

According to the communication system in the configuration 8, when various events related to the behavior of the mobile object occur, for example, a captured image or captured images required to analyze a cause of the behavior can be transmitted in a larger number or with higher resolution.

(Configuration 9) The communication system according to the configuration 8, wherein occurrence of the event that is determined by the determination section is occurrence of a predetermined abnormal state of the behavior of the mobile object.

According to the communication system in the configuration 9, a captured image or captured images required to analyze a cause of the abnormal behavior of the mobile object can be transmitted in a larger number or with higher resolution.

(Configuration 10) The communication system according to the configuration 9, wherein the abnormal state includes abrupt steering, sudden braking, and/or a collision of the mobile object.

According to the communication system in the configuration 10, in a scene where a captured image of a surrounding environment can play a significant role in analysis of the behavior of the mobile object, a sufficient number of captured images or a captured image with sufficient resolution can be transmitted by increasing the first communication volume or the ratio.

(Configuration 11) The communication system according to any one of the configurations 1 to 10, wherein when it is determined by the determination section that the event occurs, the communication control section informs the mobile communication terminal, by using the second communication section, of at least one of occurrence of the event and limitation to a communication volume of the second communication.

According to the communication system in the configuration 11, since a user of the mobile communication terminal can find in advance by the information that the communication volume of the second communication relevant to the mobile communication terminal may be limited, a feeling of strangeness about slowness of communication by the mobile communication terminal or the like can be mitigated.

(Configuration 12) The communication system according to any one of the configurations 1 to 11, wherein the communication system includes a camera including an image pick-up device, or a driving recorder including an image pick-up device.

According to the communication system in the configuration 12, the communication system of the present disclosure can be configured by extending functionality of a camera or a driving recorder.

(Configuration 13) The communication system according to any one of the configurations 1 to 12, wherein the communication system is provided to a mobile object, and as the communication relaying processing, the communication control section relays a communication to or from the external communication apparatus, for the mobile communication terminal existing in the mobile object.

According to the communication system in the configuration 13, various information, such as images of surroundings, acquired with movement of the mobile object such as a vehicle can be transmitted.

### REFERENCE SIGNS LIST

1 Communication system
10 Processor
11 First communication section
12 Second communication section
13 Image capture control section
14 Determination section
15 Communication control section
20 Memory
21 Communication control program
30 NAD
31 Antenna
32 Image pick-up device
34 GNSS sensor
35 Accelerometer
40 In-vehicle communication network
51, 51a, 51b Mobile communication terminal
60, 61, 62 Line
100 Vehicle (mobile object)
300 Base station for cellular communication
310 Router at Wi-Fi spot
500 Wide area network
510 External communication apparatus
510a Image management server
510b Information provision server
U, U1, U2 User

What is claimed is:

1. A communication system comprising:
a first communication section that performs communication via a first communication network with an external communication apparatus;
a second communication section that performs communication via a second communication network with a mobile communication terminal;
a communication control section that controls operation of the first communication section and the second communication section; and
a determination section that determines whether or not a predetermined event occurs,
wherein the communication control section performs communication relaying processing of performing communication between the mobile communication terminal and the external communication apparatus, by relaying between the first communication network and the second communication network by using the first communication section and the second communication section, and
the communication control section sets at least one of a control target relevant to a first communication volume related to a first communication and a control target relevant to a second communication volume related to a second communication, based on a result of determination performed by the determination section as to whether or not the predetermined event occurs, the first communication being not a communication through the communication relaying processing among communications via the first communication network, the second communication being a communication through the communication relaying processing among communications via the first communication network.

2. The communication system according to claim 1, wherein when it is determined by the determination section that the event occurs, the communication control section sets a control target of the first communication volume, or a control target of a ratio of the first communication volume to the second communication volume, at a larger value than when it is determined that the event does not occur.

3. The communication system according to claim 1, wherein when it is determined by the determination section that the event occurs, the communication control section sets a control target of the second communication volume, or a control target of a ratio of the second communication volume to the first communication volume, at a smaller value than when it is determined that the event does not occur.

4. The communication system according to claim 1, wherein the first communication is a communication that transmits image data captured by an image pick-up device to the external communication apparatus.

5. The communication system according to claim 1, wherein the determination section determines whether or not the event occurs, based on image data captured by an image pick-up device.

6. The communication system according to claim 5, wherein occurrence of the event that is determined by the determination section is occurrence of a predetermined abnormal state in an installation environment where the image pick-up device is installed.

7. The communication system according to claim 6, wherein the abnormal state includes existence of a disaster, an accident, an emergency vehicle, and/or a suspicious person in the installation environment.

8. The communication system according to claim 1, wherein the determination section determines whether or not the event occurs, based on behavior of a mobile object on which the communication system is used.

9. The communication system according to claim 8, wherein occurrence of the event that is determined by the determination section is occurrence of a predetermined abnormal state of the behavior of the mobile object.

10. The communication system according to claim 9, wherein the abnormal state includes abrupt steering, sudden braking, and/or a collision of the mobile object.

11. The communication system according to claim 1, wherein when it is determined by the determination section that the event occurs, the communication control section informs the mobile communication terminal, by using the second communication section, of at least one of occurrence of the event and limitation to a communication volume of the second communication.

12. The communication system according to claim 1, wherein the communication system includes a camera including an image pick-up device, or a driving recorder including an image pick-up device.

13. The communication system according to claim 1, wherein
the communication system is provided to a mobile object, and
as the communication relaying processing, the communication control section relays a communication to or from the external communication apparatus, for the mobile communication terminal existing in the mobile object.
